(19) United States
(12) Patent Application Publication
(10) Pub. No.: US 2016/0379366 A1
(43) Pub. Date: Dec. 29, 2016

(54) ALIGNING 3D POINT CLOUDS USING LOOP CLOSURES

(71) Applicant: Microsoft Technology Licensing, LLC, Redmond, WA (US)

(72) Inventors: CHINTAN ANIL SHAH, Boulder, CO (US); JEROME FRANCOIS BERCLAZ, Sunnyvale, CA (US); MICHAEL L. HARVILLE, Palo Alto, CA (US); YASUYUKI MATSUSHITA, Osaka (JP); TAKAAKI SHIRATORI, Beijing (CN); TAOYU LI, Beijing (CN); TAEHUN YOON, Superior, CO (US); STEPHEN EDWARD SHILLER, Littleton, CO (US); TIMO P. PYLVAENAEINEN, Menlo Park, CA (US)

(21) Appl. No.: 14/749,876

(22) Filed: Jun. 25, 2015

(51) Int. Cl. G06T 7/00

(52) U.S. Cl. CPC G06T 7/0028; G06T 7/0051; G06T 2207/10028

(57) ABSTRACT

Systems, methods, and computer-readable storage media are provided for aligning three-dimensional point clouds that each includes data representing at least a portion of an area-of-interest. The area-of-interest is divided into multiple regions, each region having a closed-loop structure defined by a plurality of border segments, each border segment including a plurality of fragments. Point clouds representing the fragments that make up each closed-loop region are aligned with one another in a parallelized manner, for instance, utilizing a Simultaneous Generalized Iterative Closest Point (SGICP) technique, to create aligned point cloud regions. Aligned point cloud regions sharing a common border segment portion are aligned with one another to create a single, consistent, aligned point cloud having data that accurately represents the area-of-interest.

### BACKGROUND

With recent advances in depth sensing devices and methods, three-dimensional point clouds (i.e., sets of data points wherein each data point represents a particular location in three-dimensional space) have become an increasingly common source of data for computer vision tasks such as three-dimensional model reconstruction, pose estimation, and object recognition. In some such applications, obtaining the point cloud data requires sensor motion over time, and perhaps use of multiple sensors (e.g., Light Detection and Ranging (LiDAR) sensors) or multiple sweeps (i.e., 360° rotations) of a single sensor. These point clouds captured at different times and/or with multiple devices are spatially aligned (i.e., registered) with respect to one another prior to further data analysis.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In various embodiments, systems, methods, and computer-readable storage media are provided for aligning three-dimensional point clouds that each includes data representing the location of the points comprising the respective point clouds as such points relate to at least a portion of an area-of-interest. The area-of-interest may be divided into multiple regions or partitions (these terms being used interchangeably herein), each region having a closed-loop structure defined by a plurality of border segments, each border segment including a plurality of fragments. In embodiments, the area-of-interest may be quite large (e.g., hundreds of square kilometers). Each fragment may contain point clouds having data from one or more point-capture devices and/or one or more sweeps (i.e., 360° rotations) from individual point capture devices. Point clouds representing the fragments that make up each closed-loop region may be spatially aligned with one another in a parallelized manner, for instance, utilizing a Simultaneous Generalized Iterative Closest Point (SGICP) technique, to create aligned point cloud regions. Aligned point cloud regions sharing a common border segment portion may be aligned with one another, e.g., by performing a least-squares adjustment, to create a single, consistent, aligned point cloud having data that accurately represents the area-of-interest. In embodiments, high-confidence locations (for instance, derived from Global Positioning System (GPS) data) may be incorporated into the point cloud alignment to improve accuracy.

Simultaneous alignment utilizing closed-loop regions significantly improves point cloud quality. Exemplary embodiments attempt to ensure that point clouds having data representing at least a portion of the area-of-interest benefit from this by incorporating them into separate region sub-problems. The SGICP technique effectively re-estimates capture path segments within each region, allowing them to non-rigidly deform in order to jointly improve the accuracy of the alignment of the points. Additionally, intra-region registration (that is, alignment of the point clouds that include data representative of the same closed-loop region) may be applied to the border segments making up each of the individual closed-loop regions in parallel, thereby enabling significant reduction of computation time and complexity compared with conventional simultaneous alignment methods.

### BRIEF DESCRIPTION OF THE DRAWINGS

The present invention is illustrated by way of example and not limitation in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a schematic diagram illustrating an area-of-interest at the city-scale divided into two closed-loop regions that share a common border segment portion, in accordance with an embodiment of the present invention;

FIGS. 4A and 4B are schematic diagrams illustrating intra-region alignment of one of the two closed-loop regions of FIG. 3 (region 310), in accordance with an embodiment of the present invention;

FIGS. 5A and 5B are schematic diagrams illustrating inter-region alignment of the two closed-loop regions of FIG. 3 after intra-region alignment has been completed for each region, in accordance with an embodiment of the present invention;

FIGS. 6A and 6B are schematic diagrams illustrating point cloud data representative of an area-of-interest before and after alignment, respectively, in accordance with embodiments of the present invention;

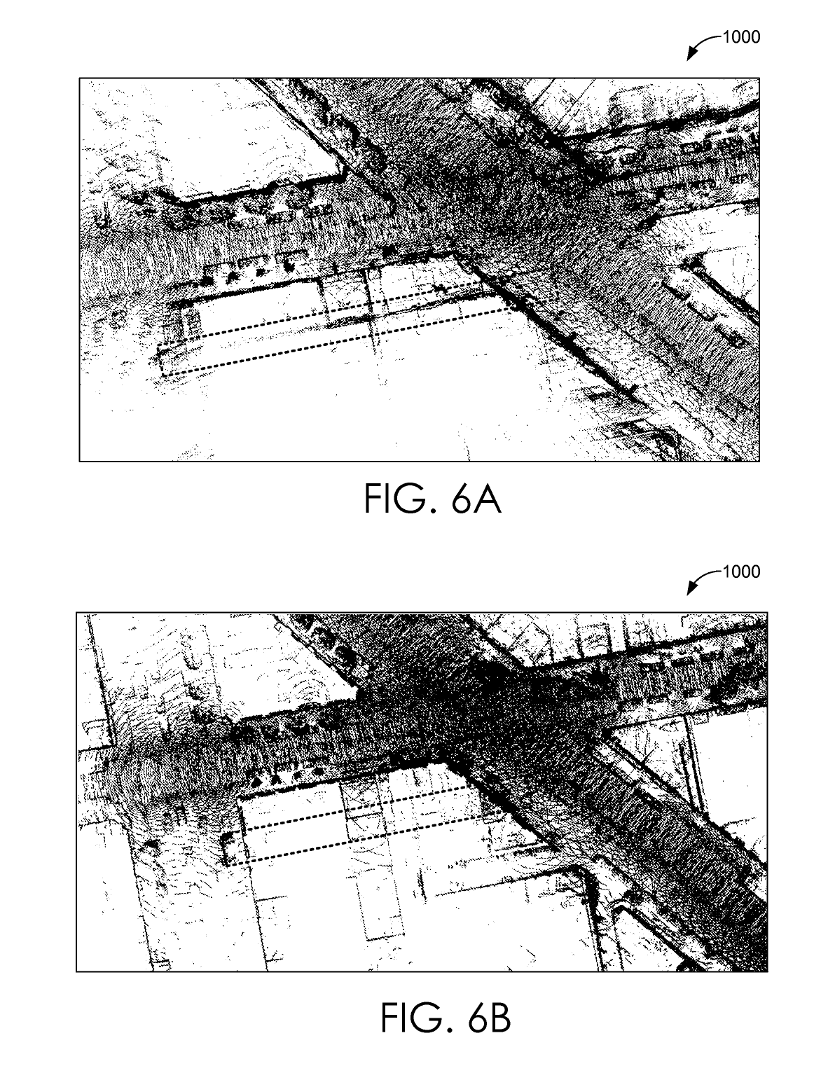

FIG. 7 is a flow diagram showing an exemplary method for aligning three-dimensional point clouds using loop closures, in accordance with an embodiment of the present invention; and

FIG. 8 is a flow diagram showing another exemplary method for aligning three-dimensional point clouds using loop closures, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Many three-dimensional modeling techniques show good results for objects and environments of a few meters in size. Modeling at the larger scales of indoor environments and entire cities, however, remains technically challenging. In these cases, many point cloud “frames” (that is, 360° rotational sweeps of a point-capture device) captured along one or more complex sensor paths need to be placed in a consistent three-dimensional coordinate system. Straight-forward application of known approaches such as Iterative Closest Point (ICP) technique and its variants leads to many small frame-to-frame alignment errors that often accumulate to produce gross distortions in the final result. At the same time, computation and memory requirements can easily become infeasible, particularly when methods jointly align many point clouds.

Various aspects of the technology described herein are generally directed to systems, methods, and computer-readable storage media for aligning, with one another and with the physical world, three-dimensional point clouds that each includes data representing at least a portion of an area-of-interest. The “area-of-interest” may be, by way of example only, at least a portion of a city or at least a portion of an interior layout of a physical structure such as a building. As utilized herein, a “point cloud” is a set of data points in a three-dimensional coordinate system that represents the external surface of objects and illustrates their location in space. Point clouds may be captured by remote sensing technology, for instance, Light Detection and Ranging (LiDAR) scanners that rotate 360° collecting points in three-dimensional space. The area-of-interest may be divided into multiple regions, each region having a closed-loop structure, that is, a structure defined by a plurality of border segments that collectively define a continuous border that begins and ends at the same location or node, each border segment including a plurality of fragments. An exemplary closed-loop region may be, by way of example only, a city block. Each fragment included in a border segment may have representative data included in point clouds derived from one or more point-capture devices (e.g., LiDAR scanners) and/or one or more sweeps (i.e., 360° rotations) from individual point capture devices. Point clouds representing the fragments that make up each closed-loop region may be spatially aligned (i.e., registered) with one another in a parallelized manner (that is, at least substantially simultaneously), for instance, utilizing a Simultaneous Generalized Iterative Closest Point (SGICP) technique known to those of ordinary skill in the art, to create aligned point cloud regions. Aligned point cloud regions sharing a common border segment portion (wherein such portion may be an entire border segment or any lesser portion thereof) may be aligned with one another, e.g., by performing a least-squares adjustment, to create a single, consistent, aligned point cloud having data that accurately represents the area-of-interest. In embodiments, high-confidence locations, for instance, derived from Global Positioning System (GPS) data, may be incorporated into the point cloud alignment to improve accuracy.

Accordingly, exemplary embodiments are directed to methods being performed by one or more computing devices including at least one processor, the methods for aligning point clouds to a physical world for which modeling is desired. The methods may include receiving a plurality of point clouds, each point cloud including data representative of at least a portion of an area-of-interest. The method further may include dividing the area-of-interest into multiple closed-loop regions each defined by a plurality of border segments, each border segment defining a distance between two nodes (e.g., intersections defining a city block or other locations where the direction between one border segment and an adjacent border segment defining the same closed-loop region changes), wherein at least a first of the multiple closed-loop regions shares a common border segment portion with at least a second of the multiple closed-loop regions, wherein each border segment is comprised of a plurality of fragments, and wherein multiple point clouds of the plurality of point clouds represent each fragment. Further, the method may include, for each of the plurality of fragments that comprises each of the plurality of border segments defining a first of the multiple closed-loop regions, aligning the representative multiple point clouds with one another to create a first aligned closed-loop region (that is, a first closed-loop region wherein all representative point clouds are aligned with one another and the first closed-loop region is aligned to the physical world for which modeling is desired); for each of the plurality of fragments that comprise each of the plurality of border segments defining a second of the multiple closed-loop regions, aligning the representative multiple point clouds with one another to create a second aligned closed-loop region (that is, a second closed-loop region wherein all representative point clouds are aligned with one another and the second closed-loop region is aligned to the physical world for which modeling is desired); and aligning the first aligned closed-loop region and the second aligned closed-loop region along the common border segment portion.

Other exemplary embodiments are directed to systems for aligning three-dimensional point clouds that each includes data representative of at least a portion of an area-of-interest. Systems may include a vehicle configured for moving through the area-of-interest, a plurality of Light Detection and Ranging (LiDAR) sensors coupled with the vehicle, and a point cloud alignment engine. A “vehicle,” as utilized herein, may include any space-borne, air-borne, or ground-borne medium capable of moving along and among the border segments comprising various closed-loop regions within an area-of-interest. The point cloud alignment engine may be configured for receiving a plurality of three-dimensional point clouds that each may include data representative of at least a portion of the area-of-interest. The point cloud alignment engine further may be configured for dividing the area-of-interest into a plurality of closed-loop regions each defined by a plurality of border segments and each border segment defining a distance between two nodes. Each border segment may be comprised of a plurality of fragments and multiple point clouds may represent each fragment. For each of the plurality of fragments that comprises each of the plurality of border segments defining a first of the multiple closed-loop regions, the point cloud alignment engine additionally may be configured for spatially aligning the representative multiple point clouds with one another to create a first aligned closed-loop region; for each of the plurality of fragments that comprises each of the plurality of border segments defining a second of the multiple closed-loop regions, spatially aligning the representative multiple point clouds with one another to create a second aligned closed-loop region, wherein the first aligned closed-loop region and the second aligned closed-loop region share a common border segment portion; and spatially aligning the first aligned closed-loop region with the second aligned closed-loop region along the common border segment portion.

Yet other exemplary embodiments are directed to methods being performed by one or more computing devices including at least one processor, the methods for aligning three-dimensional point clouds. The method may include dividing an area-of-interest into multiple closed-loop regions each defined by a plurality of border segments, each border segment defining a distance between two nodes. At least a first of the multiple closed-loop regions may share a common border segment portion with at least a second of the multiple closed-loop regions, each border segment may be comprised of a plurality of fragments, and multiple point clouds of the plurality of point clouds may represent each fragment. The method further may include spatially aligning the representative multiple three-dimensional point clouds for each of the plurality of fragments that comprises each of the plurality of border segments defining each of the multiple closed-loop regions, creating a plurality of aligned closed-loop regions within the area of interest; and spatially aligning the aligned closed-loop regions into a single aligned three-dimensional point cloud representative of the area-of-interest according to, for instance, a least squares optimization with closed form solution.

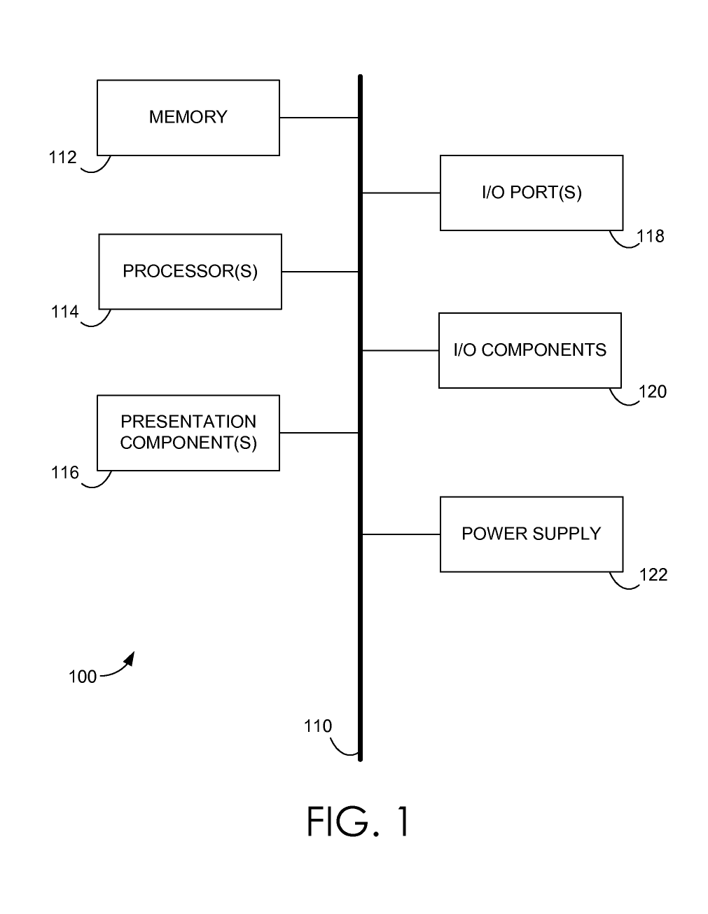

Having briefly described an overview of certain embodiments of the technology described herein, an exemplary operating environment in which at least exemplary embodiments may be implemented is described below in order to provide a general context for various aspects of the described technology. Referring to the figures in general and initially to FIG. 1 in particular, an exemplary operating environment for implementing certain embodiments of the described technology is shown and designated generally as computing device 100. The computing device 100 is but one example of a suitable computing environment and is not intended to suggest any limitation as to the scope of use or functionality of embodiments hereof. Neither should the computing device 100 be interpreted as having any dependency or requirement relating to any one component nor any combination of components illustrated.

Embodiments of the present invention may be described in the general context of computer code or machine-useable instructions, including computer-useable or computer-executable instructions such as program modules, being executed by a computer or other machine, such as a personal data assistant or other handheld device. Generally, program modules include routines, programs, objects, components, data structures, and the like, and/or refer to code that performs particular tasks or implements particular abstract data types. Exemplary embodiments of the invention may be practiced in a variety of system configurations, including, but not limited to, hand-held devices, consumer electronics, general-purpose computers, more specialty computing devices, and the like. Exemplary embodiments also may be practiced in distributed computing environments where tasks are performed by remote-processing devices that are linked through a communications network.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more exemplary embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excluding signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures (i.e., gestures made in the air by one or more parts of a user's body or a device controlled by a user's body), voice, or other physiological inputs generated by a user. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a mobile device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices. The computer-useable instructions form an interface to allow a computer to react according to a source of input. The instructions cooperate with other code segments to initiate a variety of tasks in response to data received in conjunction with the source of the received data.

As previously set forth, exemplary embodiments of the present invention provide systems, methods, and computer-readable storage media for spatially aligning three-dimensional point clouds that each includes data representative of at least a portion of an area-of-interest potentially obtained by many capture devices and along multiple capture paths, in a manner that is both accurate and highly parallelizable for efficient computation. From an initial estimate of the sensor paths, a three-dimensional graph is constructed of the intersection and connectivity of the point clouds. The overall alignment problem is decomposed into smaller ones based on the loop closures that exist in this graph. Each loop may be composed of segments of different device acquisition paths. This decomposition may be paired, for example, with a local alignment technique called SGICP, based on Generalized-ICP, which exploits the loop closure property to produce highly accurate intra-region (i.e., within a particular region) alignment results. The individual regions are then combined into a single, consistent point cloud via an inter-region (i.e., between two or more regions) alignment step that reconnects the graph of regions with minimal distortion, according to, by way of example only, a least squares optimization with closed form solution. In embodiments, this last step may be constrained with high-confidence locations within the initial device capture path estimates, thereby producing a final result that is better anchored, for example, to an external reference coordinate system.

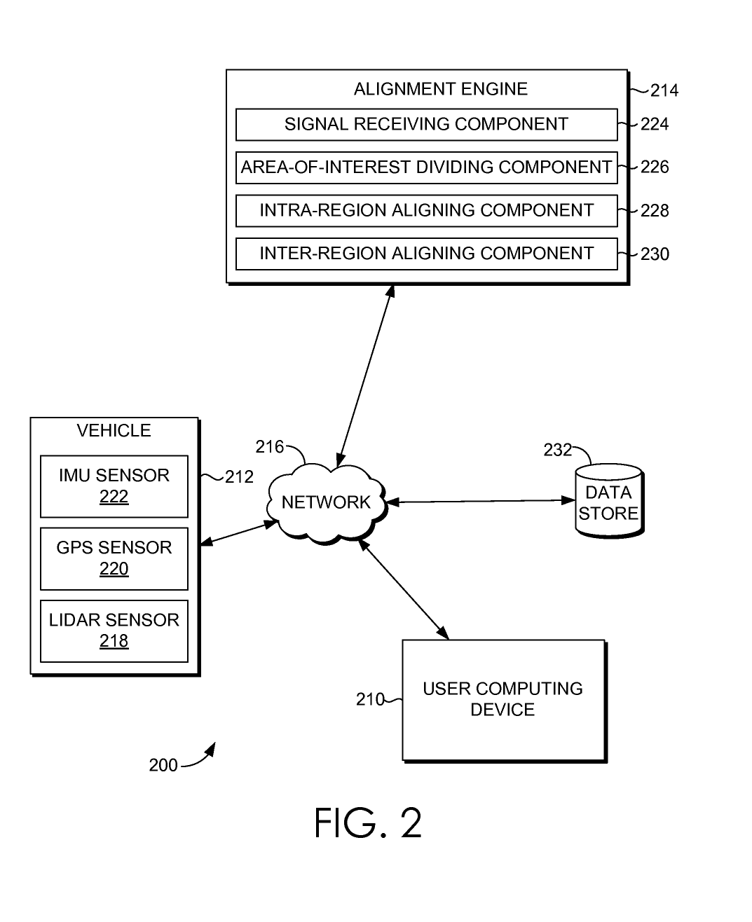

Referring now to FIG. 2, a block diagram is provided illustrating an exemplary computing system 200 in which embodiments of the present invention may be employed. Generally, the computing system 200 illustrates an environment in which sensor data points (for instance, Light Detection and Ranging (“LiDAR”), Global Positioning System (“GPS”) and Inertial Measurement Unit (“IMU”) data points) may be collected and resultant point clouds may be spatially aligned. Among other components not shown, the computing system 200 generally includes a user computing device 210, a vehicle 212 having one or more sensors coupled therewith for collecting data points, and an alignment engine 214, all in communication with one another via a network 216. The network 216 may include, without limitation, one or more local area networks (LANs) and/or wide area networks (WANs). Such networking environments are commonplace in offices, enterprise-wide computer networks, intranets and the Internet. Accordingly, the network 216 is not further described herein.

It should be understood that any number of user computing devices 210, vehicles 212, and/or alignment engines 214 may be employed in the computing system 200 within the scope of embodiments of the technology described herein. Each may comprise a single device/interface or multiple devices/interfaces cooperating in a distributed environment. For instance, the alignment engine 214 may comprise multiple devices and/or modules arranged in a distributed environment that collectively provide the functionality of the alignment engine 214 described herein. Additionally, other components or modules not shown also may be included within the computing system 200.

In some embodiments, one or more of the illustrated components/modules may be implemented as stand-alone applications. In other embodiments, one or more of the illustrated components/modules may be implemented via the user computing device 210, the alignment engine 214, or as an Internet-based service. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located in association with any number of alignment engines 214 or user computing devices 210. By way of example only, the alignment engine 214 might be provided as a single computing device (as shown), a cluster of computing devices, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The user computing device 210 may include any type of computing device, such as the computing device 100 described with reference to FIG. 1, for example. Generally, the user computing device 210 is configured to receive content for presentation, for instance, spatially aligned point cloud data, from the alignment engine 214. It should be noted that embodiments of the present invention are equally applicable to mobile computing devices and devices accepting touch, gesture, and/or voice input. Any and all such variations, and any combination thereof, are contemplated to be within the scope of embodiments of the present invention.

In accordance with embodiments of the present invention, point clouds are acquired from one or more vehicles 212 moving throughout an area-of-interest. It will be understood that the term “vehicle” is used generically herein to refer to a device of any size or type that is capable of moving through an area-of-interest. Vehicles may include any space-borne, air-borne, or ground-borne medium capable of moving along and among an area-of-interest and are not intended to be limited to traditional definitions of the term “vehicle.” For instance, human, animal and/or robotic mediums moving along and among an area-of-interest may be considered “vehicles” in accordance with exemplary embodiments hereof. Smaller areas-of-interest may necessitate vehicles of smaller size or configuration than traditional vehicles. Any and all such variations, and any combination thereof, are contemplated to be within the scope of embodiments hereof.

In embodiments, point clouds are obtained from sensors coupled with the vehicles 212. In one exemplary embodiment, one or more LiDAR sensors 218 are coupled with a vehicle. In other exemplary embodiments, point clouds may be obtained utilizing any type of depth-sensing camera and/or via triangulation from two or more images captured by a moving vehicle, e.g., using methods commonly referred to in the art as “structure from motion.” Additionally, initial estimates of the capture paths may be derived from one or more GPS sensors 220 and/or one or more IMU sensors 222 coupled with the vehicle 212. Any and all such variations, and any combination thereof, are contemplated to be within the scope of embodiments hereof.

As illustrated, the alignment engine 214 includes a signal receiving component 224, an area-of-interest dividing component 226, an intra-region aligning component 228 and an inter-region aligning component 228. Signals collected from the sensors 218, 220, 222 (or otherwise obtained as described above) are provided to the alignment engine 214, for instance, via the network 216. In this regard, the signal receiving component 224 is configured for receiving signals, for instance, from the vehicle sensors 218, 220, 222.

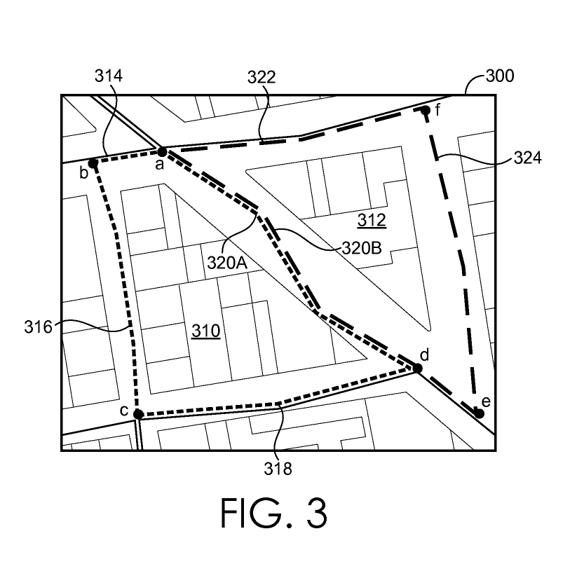

The area-of-interest dividing component 226 is configured for dividing point clouds comprised of the received sensor points into one or more closed-loop regions comprising an initial-point-capture path estimate. With reference to FIG. 3, a graph showing an area of interest 300 is illustrated as being partitioned into two regions, 310 and 312. Each region 310, 312 has a closed-loop structure, that is, a structure defined by a plurality of border segments or edges (314, 316, 318, 320A defining region 310 and 320B, 322 and 324 defining region 312). Each border segment (i.e., edge) defines a distance between two nodes. For instance, the border segment 314 defines a distance between nodes a and b, the border segment 316 defines a distance between nodes b and c, the border segment 318 defines a distance between nodes c and d, the border segment 320A defines a distance between nodes a and d, the border segment 322 defines a distance between nodes a and f, the border segment 324 defines a distance between nodes f and e, and the border segment 320B defines a distance between nodes a and e. The border segments comprising each region 310, 312 collectively define a continuous border that begins and ends at the same location or node. Each node (e.g., a, b, c, d, e, f) represents a location at which a vehicle path crosses either itself or another path. Border segments are created between node pairs that are directly connected (i.e., no intervening nodes) along at least one vehicle's path. The geometric shape of the vehicle path between two directly connected nodes is retained, and these paths are frequently not straight lines between the nodes' respective geographic locations. As illustrated, the regions 310 and 312 share a boundary segment portion or edge portion, boundary segment 320A being common with a portion of boundary segment 320B.

If multiple drives occur between two nodes, these path segments may be clustered according to their shape, and each cluster may become a separate border segment between the nodes. The graph may be formed directly from the paths estimated from GPS/IMU data by first creating nodes where paths converge within a threshold distance from sufficiently different directions or where a path begins traversal through a location previously visited by itself or another path. In embodiments, it may be useful to first associate point cloud frames or sweeps with known, high-confidence locations, for instance, on a street map of a city being modeled (such data being associated, for instance, with a database 232 to which the alignment engine 214 has access), and then form a graph based on the street connectivity.

In embodiments, the shapes of, for instance, city streets may be provided with the map. In embodiments, these shapes may be resampled at predetermined intervals, for instance, between one-meter spacing and three-meter spacing, to produce candidate point cloud assignment locations. With these candidate locations as the hidden states, a Hidden-Markov-Model-framework may perform this assignment independently for each vehicle drive, using observation probabilities based on the distance from the GPS/IMU-based point cloud location estimate and coherence between the local direction of the street and the estimated vehicle path. State transition probabilities may be determined by the length of the street route between a pair of locations, thereby encouraging continuity of assignment of a vehicle path along a connected sequence of road links.

The regions or loops 310, 312 preferably cannot be further subdivided, do not overlap, and provide complete coverage of the graph. In embodiments, the area-of-interest dividing component 226 may utilize the following method to efficiently divide a graph into a maximum number of regions with minimal overlap:

```
procedure FINDALL LOOPS(G) [symbol]      G: the graph
  S ← all edges in G [symbol]    S: Edges at which to start
  L ← Ø [symbol]     L: Set of all loops found
  while S ≠ Ø do
    e ← dequeue (S) [symbol]      Get next start edge
    l ← Ø [symbol]      New Loop edge set, initially empty
    for each end node n of e do
      if FOLLOWNEXT EDGE(G, e, n, l) then
        L ← L ∪ TrimLoop(l) [symbol]      Found a Loop
        if e ∉ l then [symbol]      Start Edge not part of it
          enqueue (S, e) [symbol]    Try it again later
  return L
procedure FOLLOWNEXTEDGE (G, e, n, l)
  if size (l) > MaxLoopSize then return false
  l ← l ∪ e [symbol]      Add edge e to loop being built
  LEFTSIDEUSED(E) ← true [symbol]      Mark as used
  if CLOSED(l) [symbol]     INVERTED(l)then
    return true [symbol]      Found loop
  for each edge ε CLOCKWISEORDER (n, e) do
    if (e ≠ ee) [symbol]     LEFTSIDEUSED(e) then
      nn ← end node of e such that n ≠ nn
      if FOLLOWNEXTEDGE(G, ee, nn, L) then
        return true [symbol]      Found loop recursively
  l ← l \ e [symbol]     No loop found; remove edge from set
  LEFTSIDEUSED(e) ← false [symbol]      Free edge for reuse
  return false
```

The above method relies on projecting the three-dimensional graph onto a planar coordinate system, so that an ordering of border segments exiting a node, relative to a given incoming border segment, may be defined. In exemplary embodiments, a two-dimensional geospatial latitude and longitude coordinate system may be utilized and border segments may be ordered in a clockwise manner. FindAllLoops initiates two depth-first searches (implemented via FollowNextEdge) at each border segment, in the directions of each end node of the beginning border segment (start edge). The depth-first search explores subsequent border segments according to Clockwise-Order, which results in a preference for taking the left-most available turn at each node. As traversal progresses, Left-SideUsed updates a “winged-edge” data structure to indicate that the “left” side of the border segment (defined relative to the direction of traversal) is part of a new region under construction. Border segments are bypassed in the exploration if they have previously been incorporated into a region on their left side. The Closed predicate is true when traversal returns to a node that has already been visited in exploration from the current beginning border segment, and TrimLoop removes any initial border segment sequence prior to the first loop node. It can occur that many left-most available turns during an exploration were actually rightward turns, such that all border segments in the final region have their left side on the exterior of the region, rather than the interior as expected. Exclusion of such regions (accomplished via Inverted) can greatly improve both the speed and simplicity of the method. In exemplary embodiments, a maximum region length may be imposed, as may a constraint that no region can be self-crossing (i.e., border segments crossing over others in the same region) in FollowNextEdge to find all the smallest, simplest regions first, and then slowly raise the maximum and remove the constraint after no more such regions can be found. The resulting, final set of regions includes each border segment in exactly two regions, except for border segments at the exterior of the planar projection of the graph.

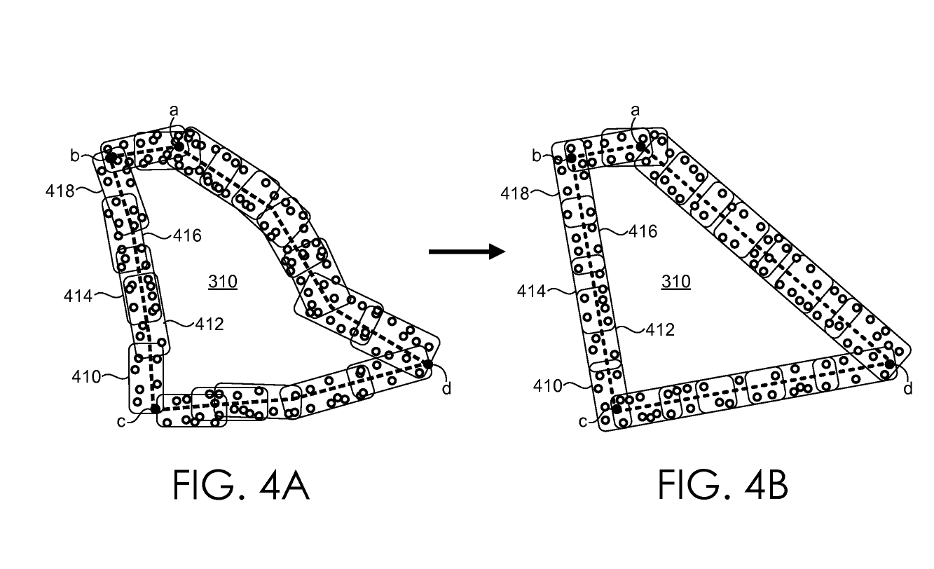

In accordance with embodiments hereof, each border segment (e.g., 314, 316, 318, 320a, 322, 324 and 320b of FIG. 3) of an initial-point-capture path estimate is comprised of a plurality of fragments, best seen with reference to FIGS. 4A and 4B wherein the exemplary city street region 310 of FIG. 3 is shown in more detail with multiple fragments 410, 412, 414, 416 and 418 before (FIG. 4A) and after intra-region alignment (FIG. 4B). Due to, for instance, multiple sweeps by individual sensors, multiple sensors, and/or multiple vehicles and vehicle paths, multiple point clouds represent each fragment. With reference back to FIG. 2, the intra-region aligning component 228 is configured to align point clouds that define each region, for instance, region 310 of FIG. 3. Accordingly, embodiments hereof involve aligning the multiple point clouds defining the fragments that comprise the border segments making up a given region to create aligned closed-loop regions. As illustrated, FIG. 4A illustrates closed loop region 310 before intra-region alignment of the fragments (e.g., 410, 412, 414, 416, 418) comprising the border segments (e.g., border segment b-c) and FIG. 4B illustrates closed loop region 310 after intra-region alignment.

In exemplary embodiments, a technique based upon the generalized ICP method may be utilized with a simultaneous aligning approach using the loop closures: Simultaneous Generalized ICP (SGICP). Similar to conventional ICP methods, the SGICP technique iterates point correspondence search and enhancement of transformation parameters of every frame, until convergence. In exemplary embodiments, for point correspondence search, KD-tree-based nearest neighbor search may be utilized, followed by thresholding for correspondent point distances. In such embodiments, the thresholding aids in removing unreliable correspondences with large distances, which are likely to be outliers. To reduce the computational cost of point correspondence search, nearest neighbor search may first be performed for each frame based on, for instance, the mean point position, and the frames may be paired if the distance between frames is less than a given threshold. Point correspondence search may then be performed for the detected frame pairs.

In exemplary embodiments, the intra-region aligning component 228 may utilize an approximate plane-to-plane distance derived from maximum likelihood estimation. In such embodiments, a rigid transformation model, i.e., rotation and translation, may be utilized for each frame (sweep) to be aligned. Given a set of point correspondences S found in pairs of frames, the objective function E to be minimized over translation t and rotation R may be defined as:

$$E = {Σ}_{( {P}_{i}^{m} , {P}_{j}^{n} ) ∈ S} {d ( {P}_{i}^{m} , {P}_{j}^{n} )}^{T} {W}_{mn}^{- 1} d ( {P}_{i}^{m} , {P}_{j}^{n} ) \qquad ( 1 )$$

where Pᵢ^{m} is the position of i-th point in the m-th frame. The distance vector d and the weighting factor W are defined as:

d(Pᵢ^{m},Pⱼ^{j})=(RₘPᵢ^{m}+tₘ)−(RₙPⱼⁿ+tₙ), (2)

Wₘₙ=Rₘ\tilde{C}_{m,i}Rₘ^{T}+Rₙ\tilde{C}_{n,j}Rₙ^{T} (3)

\tilde{C}_{m,i}=U_{m,i}diag(11ε)U_{m,i}^{T}, (4)

where U_{m,i} contains eigenvectors of the covariance matrix of points around Pᵢ^{m} and is a small constant representing variance along the normal direction and is set to 0.001.

To avoid excessive rotation and resulting erroneous point correspondences over iterations, a two-stage optimization strategy may be performed. Specifically, the transformation may be restricted to translation only, and once it is converged, the transformation may be relaxed to be rotation and translation. These steps may be as follows:

Estimation of translation t: In the first stage only with translation, the rotation parameter in equations (2) and (3) may be set to identity (R=I). This case makes the objective function E quadratic with respect to translation t, and the optimal solution can be efficiently obtained via the normal equation derived from ∂E/∂tₘ=0.

Estimation of translation t and rotation R: The second stage of translation t and rotation R estimation assumes small rotation θ_{z} around the vertical z axis. By assuming a small rotation, the rotation matrix may be approximated to a linear form as:

$$R = ( \begin{matrix}1 & {θ}_{z} & 0 \\ - {θ}_{z} & 1 & 0 \\ 0 & 0 & 1\end{matrix} ) \qquad ( 5 )$$

Due to the non-linearity of the objective function E an alternating optimization approach may be taken by treating W as an auxiliary variable. Namely, {t, R} and W may be updated one after another, by first solving equation (1) using the previous estimates of W, then updating W by

Wₘₙ←Rₘ\tilde{C}_{m,i}Rₘ^{T}+Rₙ\tilde{C}_{n,j}Rₙ^{T} (6)

using the previous estimates of R. The alternating alignment may be repeated until convergence. In the above alignment stages, the convergence criterion is defined using the norm of the parameter variations; when it becomes less than 1.0e-8 the iteration is terminated.

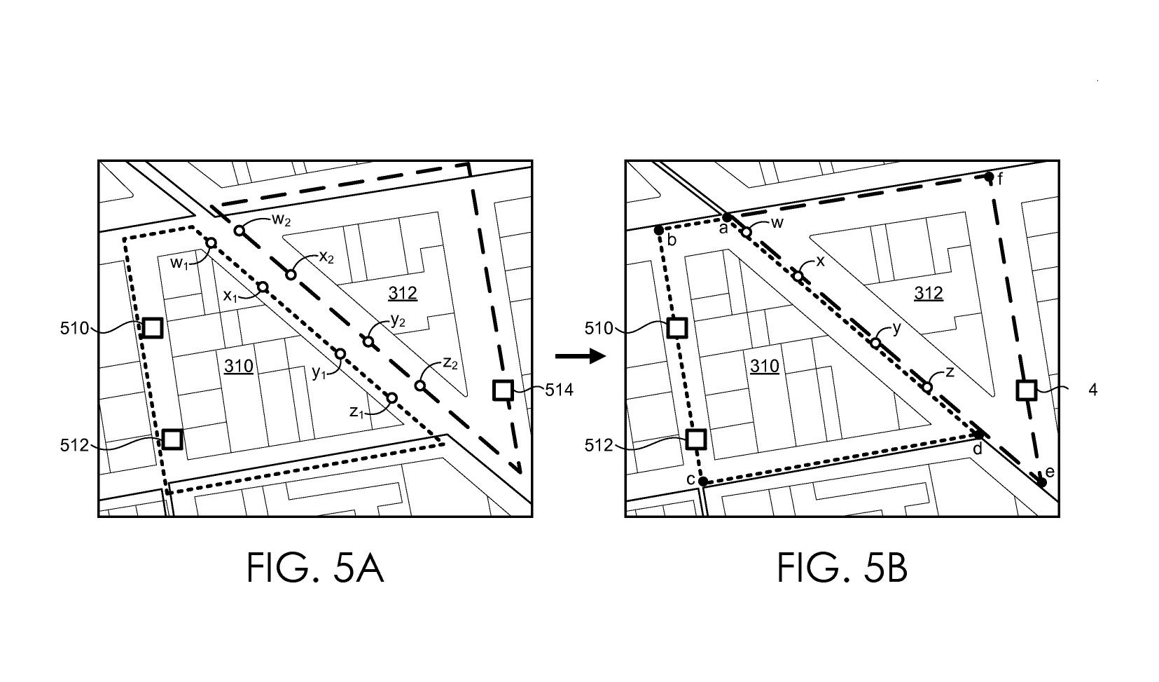

In addition to aligning data points within regions, embodiments hereof align data points between regions as well. With reference back to FIG. 2, the inter-region aligning component 230 is configured to spatially align adjacent regions in the area-of-interest with one another along common boundary segments. With reference to FIGS. 5A and 5B, inter-region alignment of the two regions 310 and 312 of FIG. 3 is illustrated. Illustrated are known points w1 and w2 of FIG. 5A (which correspond to aligned point w in FIG. 5B), x1 and x2 (which correspond to aligned point x in FIG. 5B), y1 and y2 (which correspond to aligned point y in FIG. 5B), and z1 and z2 (which correspond to aligned point z in FIG. 5B). The known points represent locations for which high-confidence spatial data is known and may be applied to improve accuracy. The dual inclusion property of border segments of a capture path graph may be relied upon in accordance with exemplary embodiments hereof to serve as a basis for such inter-region alignment. Specifically, a rigid transformation consisting of rotation matrix A and translation b for each region, sensor positions s shared by i-th and j-th loops satisfy

Aᵢs+bᵢ=Aᵢs+bⱼ (7)

where A is defined in the same manner as equation (5). The transformations may be further anchored using high-confidence sensor position data (s_{H}). When the association between s_{H} and sensor position s in i-th loop is found, the following is ensured:

Aᵢs+bᵢ=s_{H} (8)

Putting together all loops with equations (7) and (8), a sparse linear system of equations may be formulated with respect to A and b. The solution is efficiently obtained by solving the system, for instance, in a least-squares sense. Once A and b are estimated for all regions, these rigid transformations may be applied for all points to each region to produce a single, final, consistent point cloud. With reference back to FIGS. 5A and 5B, inter-region alignment of the intra-region aligned point clouds for the two regions 310 and 312 of FIG. 3 is illustrated, such inter-region alignment shown along the partially-common boundary segment consisting of segment a-d of region 310 and at least a portion of segment a-e of region 312. Point w1 of region 310 and point w2 of region 312 as shown in FIG. 5A are aligned to form final point w in FIG. 5B, point x1 of region 310 and point x2 of region 312 as shown in FIG. 5A are aligned to form final point x in FIG. 5B, point y1 of region 310 and point y2 of region 312 as shown in FIG. 5A are aligned to form final point y in FIG. 5B, and point z1 and point z2 of region 312 as shown in FIG. 5A are aligned to form final point z in a single, final, consistent point cloud, as shown in FIG. 5B. Points w, x, y and z represent objects or points for which high-confidence location information is known along the common boundary portion. It should be noted that points 510, 512 and 514 also represent points for which high-confidence location information is known, although these points are not located along a common boundary segment portion. Such information, however, may still be useful in aligning closed-loop regions to a coordinate or other system.

With reference to FIGS. 10A and 10B, the result of alignment on a much larger scale than that shown in FIGS. 3-5 is illustrated. FIG. 10A illustrates an exemplary area-of-interest 1000 before alignment in accordance with embodiments of the present invention and FIG. 10B illustrates the exemplary area-of-interest subsequent to alignment in accordance with embodiments of the present invention. In the aligned area-of-interest 1000 of FIG. 10B, the lines are much clearer and the object for which scan data is being aligned is visually tighter and more accurately aligned to the physical environment.

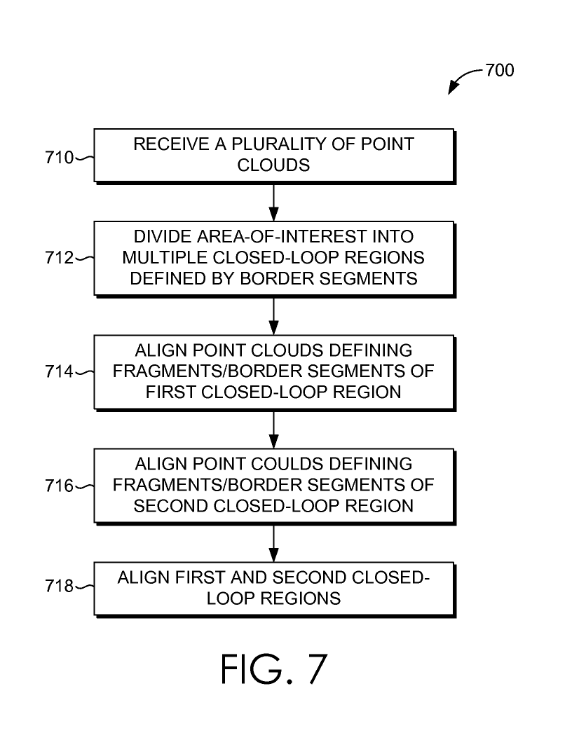

Turning now to FIG. 7, a flow diagram showing an exemplary method for aligning point clouds using loop closures, in accordance with an embodiment of the present invention, is illustrated generally as reference numeral 700. As indicated at block 710, a plurality of point clouds is received. Each received point cloud includes data representative of at least a portion of an area-of-interest. As indicated at block 712, the area-of-interest is divided into multiple closed-loop regions each defined by a plurality of border segments. Each border segment defines a distance between two nodes and shares a node with at least one other border segment of the plurality. At least a first of the multiple closed-loop regions shares a common border segment portion with at least a second of the multiple closed-loop regions. Each border segment is comprised of a plurality of fragments and multiple point clouds represent each fragment.

As indicated at block 714, for each of the plurality of fragments that comprises each of the plurality of border segments defining a first of the multiple closed-loop regions, the representative multiple point clouds are aligned with one another to create a first aligned closed-loop region. As indicated at block 716, for each of the plurality of fragments that comprises each of the plurality of border segments defining a second of the multiple closed-loop regions, the representative multiple point clouds are aligned with one another to create a second aligned closed-loop region. Finally, as indicated at block 718, the first aligned closed-loop region is aligned with the second aligned closed-loop region along the common border segment portion.

By way of example only, in city-wide environments, one or more vehicles outfitted with LiDAR sensors, travel along multiple overlapping paths through a city. Data along each capture path is divided into local point cloud “frames,” each of which is captured within a small spatio-temporal window. The estimated vehicle location and orientation, derived from on-board GPS and IMU sensors is also associated with each point cloud frame, and allows them to be approximately aligned in a global coordinate system. Due to GPS signal loss and other factors, alignment errors of up to several meters in location and a few degrees in orientation are often observable where there is spatial overlap between point cloud frames captured by different vehicle drives. To address this, a graph representation of the multiple overlapping vehicle paths may be created, in accordance with exemplary embodiments hereof, and point cloud frames assigned to border segments of the graph. The graph may be segmented into a set of adjoining regions or loops, each of which may be composed of frames from different vehicle capture paths. Next, SGICP may be used to jointly optimize alignment of all frames within each loop. This intra-region registration step may be applied to each region independently, making use of loop closure to produce self-consistent results. Finally, the loop point clouds may be aligned via a closed-form, least squares inter-region registration step that also integrates high-confidence GPS/IMU data, to produce a globally consistent and accurate city-scale point cloud.

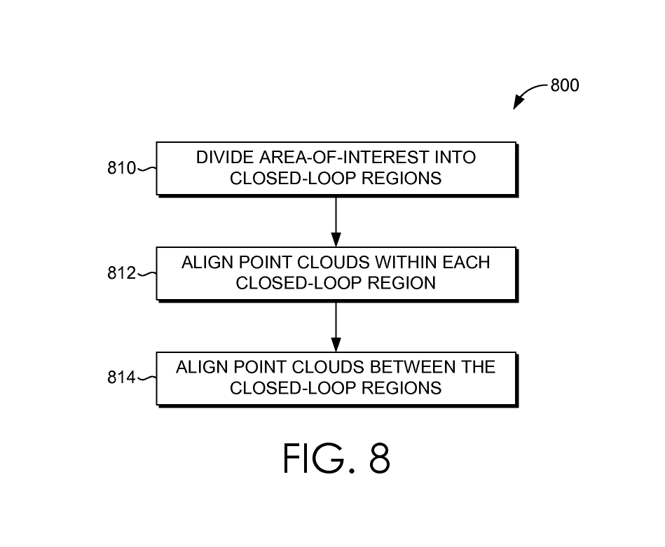

Turning now to FIG. 8, a method for registering three-dimensional point clouds is illustrated generally as reference numeral 800. As indicated at block 810, an area-of-interest is divided into multiple closed-loop regions each defined by a plurality of border segments. Each border segment defines a distance between two nodes and shares a node with at least one other border segment of the plurality. At least a first of the multiple closed-loop regions shares a common border segment portion with at least a second of the multiple closed-loop regions and multiple point clouds represent each fragment. As indicated at block 812, multiple representative three-dimensional point clouds for each of the plurality of fragments that comprises each of the plurality of border segments defining each of the multiple closed-loop regions are aligned to create a plurality of aligned closed-loop regions within the area of interest. As indicated at block 814, the aligned closed-loop regions are aligned into a single aligned three-dimensional point cloud representative of the area-of-interest according to, for instance, a least squares optimization with closed form solution.

As can be understood, embodiments of the present invention provide systems, methods, and computer-readable storage media for aligning or registering three-dimensional point clouds that each includes data representing at least a portion of an area-of-interest. The area-of-interest may be divided into multiple regions, each region having a closed-loop structure defined by a plurality of border segments, each border segment including a plurality of fragments. In embodiments, the area-of-interest may be quite large (e.g., hundreds of square kilometers). Each fragment may contain point clouds having data from one or more point-capture devices and/or one or more sweeps from individual point capture devices. Point clouds representing the fragments that make up each closed-loop region may be spatially aligned with one another in a parallelized manner, for instance, utilizing a Simultaneous Generalized Iterative Closest Point (SGICP) technique, to create aligned point cloud regions. Aligned point cloud regions sharing a common border segment portion may be aligned with one another by performing, for instance, a least-squares adjustment, to create a single, consistent, aligned point cloud having data that accurately represents the area-of-interest. In embodiments, high-confidence locations (for instance, derived from GPS data) may be incorporated into the aligned point cloud alignment to improve accuracy.

Some specific embodiments of the invention have been described, which are intended in all respects to be illustrative rather than restrictive. Alternative embodiments will become apparent to those of ordinary skill in the art to which the present invention pertains without departing from its scope.

Certain illustrated embodiments hereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the methods 700 of FIG. 7 and 800 of FIG. 8 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. A method being performed by one or more computing devices including at least one processor, the method for aligning point clouds, the method comprising:
receiving a plurality of point clouds, each point cloud including data representative of at least a portion of an area-of-interest;
dividing the area-of-interest into multiple closed-loop regions each defined by a plurality of border segments, each border segment defining a distance between two nodes, wherein at least a first of the multiple closed-loop regions shares a common border segment portion with at least a second of the multiple closed-loop regions, wherein each border segment is comprised of a plurality of fragments, and wherein multiple point clouds of the plurality of point clouds represent each fragment;
for each of the plurality of fragments that comprises each of the plurality of border segments defining a first of the multiple closed-loop regions, aligning the representative multiple point clouds with one another to create a first aligned closed-loop region;
for each of the plurality of fragments that comprises each of the plurality of border segments defining a second of the multiple closed-loop regions, aligning the representative multiple point clouds with one another to create a second aligned closed-loop region; and
aligning the first aligned closed-loop region and the second aligned closed-loop region along the common border segment portion.

2. The method of claim 1, wherein the plurality of point clouds is received from at least one of a plurality of sensors and a plurality of point-capture-paths from individual sensors of the plurality of sensors.

3. The method of claim 2, wherein at least a portion of the plurality of sensors are LiDAR sensors.

4. The method of claim 2, wherein dividing the area-of-interest into a multiple closed-loop regions comprises utilizing an initial estimate of at least a portion of the point-capture-paths associated with each sensor.

5. The method of claim 4, wherein the initial estimate of at least a portion of the point-capture-paths associated with each sensor is derived from one or both of GPS and IMU data.

6. The method of claim 4, wherein aligning the first aligned closed-loop region with the second aligned closed-loop region along the common border segment portion includes constraining the alignment of the first and second aligned closed-loop regions with one or more high-confidence locations within the initial point-capture-path estimates.

7. The method of claim 1, wherein aligning the representative multiple point clouds for each of the plurality of fragments that comprises each of the plurality of border segments defining a first of the multiple closed-loop regions to create a first aligned closed-loop region and aligning the representative multiple point clouds for each of the plurality of fragments that comprises each of the plurality of border segments defining a second of the multiple closed-loop regions to create a second aligned closed-loop region comprises aligning the representative multiple point clouds for each of plurality of fragments that comprises the plurality of border segments defining the first and the second closed-loop regions utilizing a Simultaneous Generalized Iterative Closest Point technique.

8. A system for aligning three-dimensional point clouds that each include data representative of at least a portion of an area-of-interest, the system comprising:
a vehicle configured for moving through the area-of-interest;
a plurality of LiDAR sensors coupled with the vehicle; and
a point cloud alignment engine that:
receives a plurality of three-dimensional point clouds that each includes data representative of at least a portion of the area-of-interest;
divides the area-of-interest into a multiple closed-loop regions each defined by a plurality of border segments, each border segment defining a distance between two nodes, wherein each border segment is comprised of a plurality of fragments, and wherein multiple point clouds represent each fragment;
for each of the plurality of fragments that comprises each of the plurality of border segments defining a first of the multiple closed-loop regions, aligns the representative multiple point clouds with one another to create a first aligned closed-loop region;
for each of the plurality of fragments that comprises each of the plurality of border segments defining a second of the multiple closed-loop regions, aligns the representative multiple point clouds with one another to create a second aligned closed-loop region, wherein the first aligned closed-loop region and the second aligned closed-loop region share a common border segment portion; and
aligns the first aligned closed-loop region and the second aligned closed-loop region along the common border segment portion.

9. The system of claim 8, further comprising one or more GPS sensors coupled with the vehicle.

10. The system of claim 8, further comprising one or more IMU sensors coupled with the vehicle.

11. The system of claim 8, wherein the point cloud alignment engine divides the area-of-interest into multiple closed-loop regions, at least in part, by utilizing an initial estimate of point-capture-paths associated with one or more of the plurality of LiDAR sensors.

12. The system of claim 11, wherein the point cloud alignment engine further constrains the alignment of the first aligned closed-loop region and the second aligned closed-loop region with one or more high-confidence locations within the initial point-capture-path estimates.

13. The system of claim 8, wherein the point cloud alignment engine utilizes a Simultaneous Generalized Iterative Closest Point technique to create the first and second aligned closed-loop regions.

14. The system of claim 8, wherein the point cloud alignment engine aligns the first aligned closed-loop region and the second aligned closed-loop region according to a least squares optimization with closed form solution.

15. A method being performed by one or more computing devices including at least one processor, the method for aligning three-dimensional point clouds, the method comprising:
dividing an area-of-interest into multiple closed-loop regions each defined by a plurality of border segments, each border segment defining a distance between two nodes, wherein at least a first of the multiple closed-loop regions shares a common border segment portion with at least a second of the multiple closed-loop regions, wherein each border segment is comprised of a plurality of fragments, and wherein multiple point clouds of the plurality of point clouds represent each fragment;
aligning the representative multiple three-dimensional point clouds for each of the plurality of fragments that comprises each of the plurality of border segments defining each of the multiple closed-loop regions to create a plurality of aligned closed-loop regions within the area-of-interest; and
aligning the aligned closed-loop regions along the common border segment portion to form a single aligned three-dimensional point cloud representative of the area-of-interest according to a least squares optimization with closed form solution.

16. The method of claim 15, further comprising receiving each of the plurality of point clouds from at least one of a plurality of LiDAR sensors and a plurality of point-capture-paths from individual LiDAR sensors of the plurality of LiDAR sensors.

17. The method of claim 16, wherein dividing the area-of-interest into multiple closed-loop regions comprises utilizing an initial estimate of point-capture-paths associated with at least a portion of the plurality of LiDAR sensors.

18. The method of claim 17, wherein the initial estimate of the point-capture-paths associated with at least a portion of the LiDAR sensors are derived from one or both of GPS and IMU data.

19. The method of claim 17, wherein aligning the aligned closed-loop regions along the common boundary segment portion to form a single aligned three-dimensional point cloud includes constraining the alignment of the aligned closed-loop regions with one or more high-confidence locations within the initial point-capture-path estimates.

20. The method of claim 15, wherein aligning the representative multiple three-dimensional point clouds for each of the plurality of fragments that comprises each of the plurality of border segments defining each of the multiple closed-loop regions to create a plurality of aligned closed-loop regions within the area-of-interest comprises aligning the multiple three-dimensional point clouds within each closed-loop region utilizing a Simultaneous Generalized Iterative Closest Point technique.
